(19) United States
(12) Patent Application Publication
(10) Pub. No.: US 2012/0226433 A1
(43) Pub. Date: Sep. 6, 2012

(54) System and Method for Improving the Fuel Economy of a Vehicle Combustion Engine

(75) Inventors: Mohammad M. Hasan, Pontiac, MI (US); Brian L. Hildebrand, Goodrich, MI (US)

(73) Assignee: Continental Automotive Systems, Inc., Auburn Hills, MI (US)

(21) Appl. No.: 13/037,749

(22) Filed: Mar. 1, 2011

(51) Int. Cl. F02D 41/02

(52) U.S. Cl. 701/112

(57) ABSTRACT

A system and method using a frontal distance sensor for detecting an obstacle in front of a vehicle determines the distance between the front of the vehicle and an obstacle in front of the vehicle and calculates the relative speed between the vehicle and the obstacle. If the relative speed is below a value representing a safety risk and the vehicle is decelerating, it is determined that the combustion engine torque is not required because the vehicle will likely continue to decelerate, and the combustion engine is turned off, even before the vehicle has come to a complete stop.

### FIELD OF THE INVENTION

The present invention relates to a system and method of optimizing fuel consumption of a vehicle equipped with a combustion engine.

### BACKGROUND OF THE INVENTION

A combustion engine consumes fuel whenever it is running. When the engine applies torque to a transmission, the engine burns fuel faster than when it runs at idle. It has been suggested to automatically turn off such a combustion engine when an associated vehicle stops in front of a red light or in stop-and-go traffic. This automatic function is referred to as “stop-start” operation and is commonly provided in so-called hybrid motor vehicles.

To this end, an on-board electronic processing unit evaluates the signals of wheel speed sensors and possibly a brake pedal stroke sensor to determine that the vehicle is standing still and that the driver does not intend to accelerate the vehicle at that time. Once the electronic processing unit has made the determination, it waits for a few seconds and then turns off the combustion engine, for example by shutting off a fuel supply to the engine.

It has also been suggested to observe a vehicle speed and to turn off the combustion engine when the vehicle is traveling at a slow speed, for example below 4 mph, even before the vehicle comes to a complete stop.

### SUMMARY OF THE INVENTION

It is an objective of the present invention to further improve a fuel efficiency of a vehicle.

It is a further objective of the invention to make combustion engine torque available when needed.

Another objective of the invention is to make a prediction when the vehicle will come to a stop.

According to the invention, these objectives are achieved by a system and method using at least one frontal distance sensor for detecting an obstacle in front of the vehicle, determining the distance between the front of the vehicle and the obstacle in front of the vehicle, determining the relative speed between the vehicle and the obstacle, determining that the relative speed is below a value indicating that the vehicle will rather steer around the object than stay behind the object, determining that the vehicle is slowing down, determining that the vehicle will likely continue to decelerate, and turning off the combustion engine.

An electronic controller on board of the vehicle is programmed to perform the method by processing information supplied by one or more frontal distance sensors and by turning off the combustion engine when certain criteria are met.

One or more frontal distance sensors used as part of this invention can be an infrared, ultrasound, or radar sensor or any other kind of detector, even a camera, suitable to generate an output representative of the distance between the front of the respective vehicle and the obstacle ahead. A radar sensor has the benefit of being capable of detecting multiple objects, even if they are obscured by other objects.

Vision information recognizing the activation of a preceding vehicle's brake lights or the preceding vehicle's behavior can be used to detect if the preceding vehicle will turn and get out of the path of the vehicle. This information may be used in accordance with this invention to control stop-start engine operation.

Likewise, vision information of a traffic light or a traffic sign ahead of the vehicle may be used to assess the likelihood of a stop. Speed limit signs either recognized by the forward-looking sensor or from data stored in a global positioning system (GPS) digital map can be used to determine if the traffic ahead is slowing down due to a reduced speed zone or a traffic-backup. An increase of the posted speed limit can be an indicator of an expected acceleration demand. The engine management system can use the speed limit sign information from the forward-looking sensor or from the GPS to enter or abort a specific control scenario.

The term obstacle as used throughout this description can be a resting obstacle, such as a wall or barrier, but it may also be a moving obstacle, such as another vehicle moving in traffic.

To increase precision, the system and method of this invention can also take into account whether there are feasible paths for the vehicle to steer around the obstacle. This can be accomplished by evaluating the incoming signals of the one or more distance sensors that monitor an entire angular range in the frontal region of the vehicle. Additionally, the driver's steering behavior can be observed. If the driver makes no attempt to steer around the obstacle, it is more likely that the vehicle will come to a stop.

In order to ensure that the engine is not shut off when its torque may be immediately needed, it can also be verified that the vehicle is actually slowing down and that there has not been a demand for engine torque for a specified time, e.g. 5-10 seconds. Such a demand will typically be caused by the vehicle driver pressing an accelerator pedal. If there has not been a demand for engine torque for the specified time, this is a good indicator that the driver intends to stop the vehicle.

Similarly, a large steering angle difference over the course of several seconds indicates that the driver is steering the vehicle, for example around some obstacle at slow speed. When a small steering angle change is detected it is likely that the driver intends to stop the vehicle.

Furthermore, if the driving mode of the vehicle was just changed from reverse into a forward driving mode, this action is an indication that engine torque may be needed to complete a parking maneuver or to exit from a parking space. Therefore, for a predetermined time, the engine will not be shut off absent a sustained actual stop. Also, the method can be disabled when the vehicle is traveling in reverse.

In any event, the driver can override the fuel saving system and method of this invention by engaging in one of the behaviors that abort the method. The vehicle can also include a manual input device to give the driver a choice whether to apply the method at all.

Further aspects of the invention will become apparent from the description of the attached drawing.

### BRIEF DESCRIPTION OF THE DRAWING

In the drawings,

FIG. 1 shows a schematic view of a motor vehicle equipped with forward-looking sensors in a traffic situation which incorporates the system and method in accordance with this invention; and

FIG. 2 shows a flow chart illustrating individual steps performed by the method according to the invention.

### DETAILED DESCRIPTION OF THE DRAWING

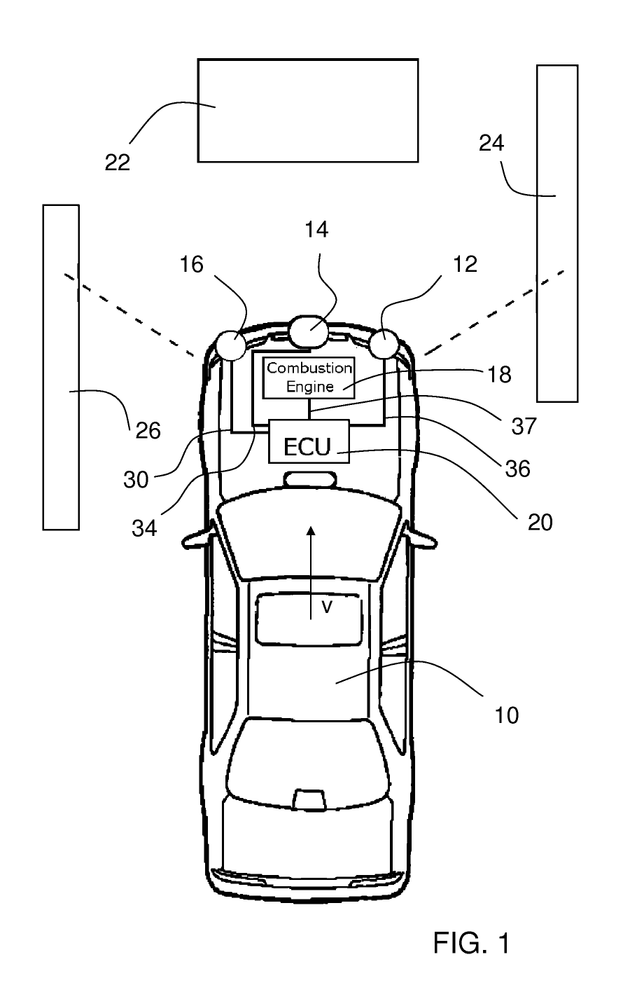

In FIG. 1, a vehicle 10 has three forward-looking sensors 12, 14, and 16. The vehicle 10 is driven by a combustion engine 18 in a moving direction indicated by a vehicle speed v. The forward-looking sensors 12, 14, and 16 monitor a detection area ahead of vehicle 10 indicated by the sector bound by dotted lines. The detection area defines a detection angle to both lateral sides of the moving direction of vehicle 10. As obstacles 22, 24, and 26 move relative to the vehicle 10 and intrude into the detection area monitored, the forward-looking sensors 12, 14, and 16 will detect each of these obstacles 22, 24, and 26 and provide signals to an onboard electronic processing unit (ECU) 20 about the location and movement of the obstacles 22, 24, and 26. In FIG. 1, electrical signal lines 30, 34, and 36 connect sensors 12, 14, and 16 respectively to ECU 20. Signal line 37 designates an electrical connection for controlling the shutting off of engine 18. The ECU 20 performs instruction steps which implement methods which apply several criteria to determine whether the vehicle 10 will come to a stop and whether the combustion engine 18 can be turned off to save fuel. These instruction steps have been stored in the ECU 20 on a computer-readable device from a computer-readable storage medium and are read by the ECU 20.

FIG. 1 is only an exemplary illustration. The vehicle 10 may include a single sensor (12, 14, or 16) covering a wide angular range or any other number of sensors instead of three forward-looking sensors 12, 14, and 16.

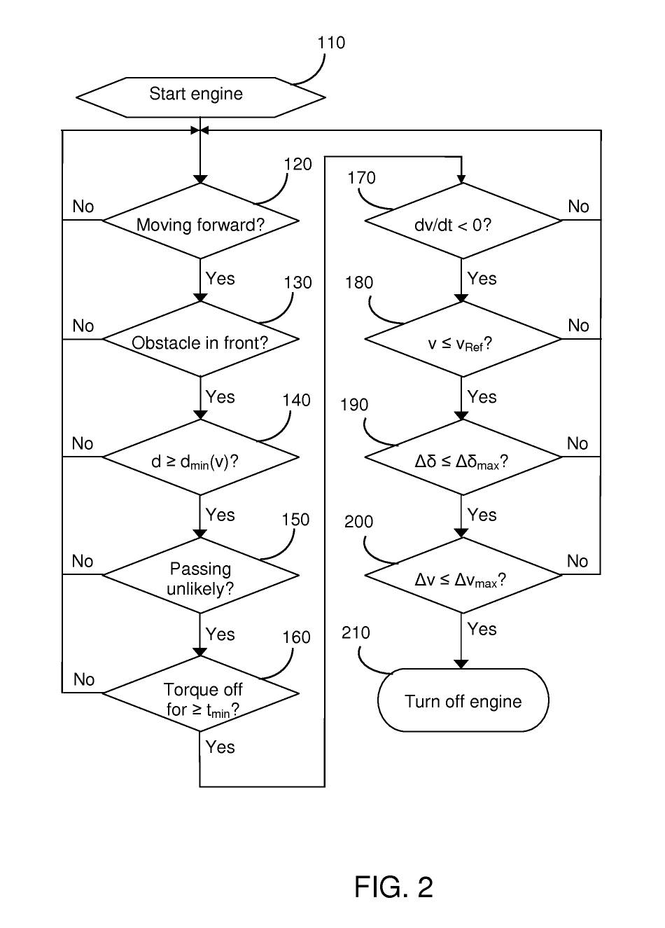

FIG. 2 shows a flow chart of one embodiment of a method to turn off the vehicle's combustion engine 18 when the combustion engine torque is not required. It is understood that the steps indicated in the flow chart do not have to be performed in the order shown or even consecutively. Any number of conditions mentioned can be verified concurrently. Also, a system performing the method may only perform a few of the steps shown in the flow chart. For example, if the vehicle 10 includes a responsive stop-start system, the combustion engine 18 can be restarted rapidly so that some of the checks can be eliminated without significantly impairing the vehicle's performance.

After the vehicle's ignition is started in step 110, the ECU 20 checks in step 120 if the vehicle 10 is actually moving forward. Because the fuel-saving method of this embodiment uses the forward-looking sensors 12, 14, and 16, it will not take any action during reverse travel. Also, when the vehicle 10 is standing still, but has a gear selector in reverse mode, the method is disabled and restarts from the beginning.

In step 130, one of the forward-looking sensors, for example forward-looking sensor 14, detects an obstacle in the vehicle path, for instance obstacle 22. This obstacle 22 may be another vehicle in traffic or a resting obstacle, such as a wall or a parked vehicle.

If the obstacle 22 is too close as determined in step 140, the vehicle driver may have to resort to a quick maneuver that may require torque from the combustion engine 18 for acceleration. In order to turn off the engine, the distance d between the vehicle 10 and the obstacle 22 must be greater than a predetermined minimum distance dₘᵢₙ. This distance may be speed-dependent because a stopping distance is greater with an increasing travel speed v:

d≧dₘᵢₙ(v).

Therefore, if the forward-looking sensor 14 detects a distance d between the vehicle 10 and the obstacle 22 that makes it unlikely that the vehicle 10 will come to a comfortable stop before colliding with the obstacle 22, the method will be aborted and starts anew as indicated in step 140.

Conversely, depending on the distance at which the sensors 12, 14, and 16 can detect an obstacle, a maximum distance between the vehicle 10 and the obstacle 22 can be set beyond which no calculations are performed. The maximum distance can be speed-dependent as well. If an obstacle is far away, no reaction may required because vehicle 10 may take a different course, or the obstacle may be removed. In such a situation, the system may wait until the vehicle 10 has approached the obstacle 22 at a distance that allows for a more reliable prediction whether the vehicle 10 will come to a stop.

In step 150, the ECU 20 calculates from the input of the one or more forward-looking sensors 12, 14, and 16 whether there is enough space to steer around the obstacle 22 so that the vehicle will likely not stop before reaching the obstacle 22. In the situation shown in FIG. 1, obstacles 24 and 26 are too close to obstacle 22 for the vehicle to pass obstacle 22 on either side. Therefore, if obstacle 22 is resting, it is likely that the vehicle 10 will not pass the obstacle, but come to a stop, and the combustion engine 18 can be turned off. There are other considerations that can be made to determine whether the vehicle will stop behind the obstacle 22 or pass it. One factor is the magnitude of braking deceleration. If the vehicle 10 is braking hard, it is more likely that it will stop than when the vehicle 10 is rolling.

If the obstacle 22 is a preceding vehicle, the one or more forward-looking sensors 12, 14, and 16 may also detect the preceding vehicle's activation of brake lights or turn signals. The ECU can then calculate from the relative movement of the two vehicles and from the preceding vehicle's lights whether the preceding vehicle is likely to move out of the trajectory of vehicle 10. If the lights of the preceding vehicle indicate that the preceding vehicle will likely move into a different lane or to take a turn, vehicle 10 will likely not stop, but pass the preceding vehicle. Thus, the inquiry of step 150 is answered in the affirmative. Accordingly, the method will be aborted if the preceding vehicle is likely to move out of the path of vehicle 10.

At least one of the forward-looking sensors, for instance sensor 12, can be a camera generating digital images. If one of obstacles 22 or 24 is a traffic light, the camera sensor 12 sends a digital image of the traffic light to the ECU 20, which processes the image to determine whether a stop is commanded. If the traffic light is in a red phase, step 150 determines that vehicle 10 is unlikely to pass the traffic light. Furthermore, if obstacle 22 is a resting vehicle and obstacle 24 is a red traffic light, the assessment that vehicle 10 will stop behind obstacle 22 is nearly certain. The ECU then determines in step 150 that passing is unlikely. Similar considerations may be applied if the camera generates an image of object 24 that the ECU interprets to be a stop sign.

Another indicator that the vehicle 10 will not accelerate immediately is the time that has passed since the last time the combustion engine torque has been used as indicated in step 160. In congested rush hour traffic, vehicles frequently move at a very low speed without stopping, and acceleration and deceleration follow each other in rapid succession. In such a situation, turning off the combustion engine 18 may not be advisable because a demand for combustion engine torque may be imminent. But if an accelerator pedal has not been depressed for at least a minimum time tₘᵢₙ, which may be in the order of magnitude of five or ten seconds, it is more likely that the vehicle 10 is coming to a stop.

The vehicle 10 should actually be slowing down according to step 170 before automatically turning off the combustion engine 18. If the time derivative dv/dt of the vehicle speed v is negative, the method according to the invention continues. Otherwise the method will be aborted and returns to its start. Thus, the engine is only shut off if:

dv/dt<0.

Also, the present travel speed v of the vehicle 10 should be smaller than a reference speed v_{Ref} as indicated in step 180:

v<v_{Ref}.

The reference speed v_{Ref} will likely be a value below 10 mph to exempt highly dynamic driving situations from a combustion engine shut-off. Only if the travel speed is below the reference speed v_{Ref}, the ECU 20 will conclude that the vehicle will come to a stop. Otherwise the method will be aborted and returns to its start.

A driver may slow down the vehicle 10 may because the driver is engaging in a steering maneuver or is entering a parking spot. Then the vehicle 10 may even come to a stand-still, but the combustion engine torque is still required if the driver intends to back up the vehicle 10 at a steering angle δ. Thus, step 190 verifies that any recent change of the steering angle Δδ is smaller than a maximum admissible steering angle difference Δδₘₐₓ:

Δδ≦Δδₘₐₓ

This maximum admissible steering angle difference Δδₘₐₓ can amount to approximately 10 or 20 degrees, depending on a range of steering angles that the vehicle 10 would adopt to travel along a winding road. Optionally, the time derivative of the steering angle may also be considered, where rapid changes of the steering angle prevent an engine shut-off. The condition for shutting off the engine is then:

dδ/dt<(dδ/dt)ₘₐₓ

According to step 200, it may also be an indication of an imminent stop if the vehicle's travel speed v is not significantly greater than the obstacle's speed. If the obstacle 22 rests, the travel speed v should be very small before the combustion engine 18 is turned off. If the obstacle 22 is moving and slowing down, the vehicle 10 should be slowing down accordingly: This limitation of the relative speed between the vehicle 10 and the obstacle 22 can be described as follows:

Δv≦Δvₘₐₓ

Otherwise, the vehicle driver may be planning some other move.

When all criteria are met as identified in the above steps, the combustion engine 18 of the vehicle 10 of the shown embodiment is turned off in step 210 to save fuel.

If the vehicle 10 is a hybrid vehicle with an electric motor as an alternative source of torque, the decision to turn off the combustion engine 18 is less critical and may be made dependent on only a few of the criteria listed above. The electric motor can supply torque for a short time until the combustion engine 18 is restarted.

The combustion engine 18 restarts as soon as combustion engine torque is required again. The restart is typically triggered when the driver presses the accelerator pedal.

For added information and plausibility considerations, data from a global positioning system (GPS) can be evaluated to determine if the vehicle is approaching a zone with a lower speed limit or a traffic back-up. Of particular help is a GPS set up to receive and provide real-time information on prevailing traffic. GPS data can also be used to verify whether the vehicle is entering a garage or driveway or approaching a stop sign or traffic light.

The described embodiment represents only one of many examples of the present invention. The invention is not limited to the types of sensors described or to the verifications performed in the embodiment. Other verifications may be performed that have not been included in this embodiment. Their absence does not indicate that they fall outside the scope of this invention. Such verifications could, for example, include considering road conditions to estimate a required braking distance, or exploiting data from a telematics system to evaluate prevailing traffic conditions, for instance to determine whether a traffic back-up is ahead, and more.

What is claimed is:

1. A method for improving the fuel economy of a vehicle, the vehicle having at least one frontal sensor and a combustion engine providing a driving torque, the method comprising the steps of:
detecting an obstacle in front of the vehicle using the sensor,
determining a relative speed between the vehicle and the obstacle,
determining that the relative speed is below a predetermined value,
determining that the vehicle is decelerating,
determining from the relative speed between the vehicle and the obstacle that the vehicle will likely continue to decelerate, and
turning off the combustion engine.

2. The method of claim 1, wherein the vehicle is moving in a driving direction, the method including the further step of:
detecting an obstacle in an angular range of at least 45 degrees to each side of the driving direction, and
determining that it is unlikely that the vehicle will steer around the obstacle.

3. The method of claim 1, wherein the vehicle moves at a travel speed and the determination that the vehicle will likely continue to decelerate includes the step of:
determining that the travel speed is below a predetermined threshold.

4. The method of claim 1, wherein the determination that the vehicle will likely continue to decelerate includes the step of:
determining that the combustion engine has run idle for a predetermined time.

5. The method of claim 1 for a vehicle with a steering angle sensor detecting a steering angle, wherein in the determination that the vehicle will likely continue to decelerate includes the step of:
determining that for a predetermined time the steering angle has remained within a predetermined angular range.

6. The method of claim 1, wherein the vehicle is traveling at a travel speed, the method comprising the additional steps of:
determining a distance between the front of the vehicle and the obstacle in front of the vehicle,
determining that the distance between the vehicle and the obstacle exceeds a minimum distance that is positively correlated with the travel speed.

7. The method of claim 1, wherein the vehicle is traveling at a travel speed, the method comprising the additional steps of:
determining a distance between the front of the vehicle and the obstacle in front of the vehicle,
determining that the distance between the vehicle and the obstacle is smaller than a maximum distance beyond which predictions are unreliable.

8. The method of claim 1, comprising the step of:
determining that the vehicle is not traveling in reverse and has not traveled in reverse for a predetermined time.

9. The method of claim 1, further comprising the steps of:
evaluating telematics data for current traffic conditions, and
determining that a traffic back-up has built up ahead of the vehicle.

10. The method of claim 1, further comprising the step of:
evaluating data from a global positioning system, and
determining that the vehicle is approaching a traffic signal or traffic sign commanding a stop.

11. The method of claim 1, wherein the obstacle is a traffic sign, the method further including the steps of
analyzing the traffic sign, and
determining that the traffic sign commands a stop.

12. The method of claim 1, wherein the obstacle is a traffic light, the method further including the steps of
analyzing the traffic light, and
determining that the traffic light commands a stop.

13. The method of claim 1, wherein the obstacle is a preceding vehicle with at least one brake light, the method further comprising the steps of:
determining that the obstacle is a preceding vehicle,
detecting an actuation of the at least one brake light,
determining that the obstacle is likely to remain in front of the vehicle.

14. The method of claim 1, wherein the obstacle is a preceding vehicle with at least one turn signal light on each side, the method further comprising the steps of:
determining that the obstacle is a preceding vehicle,
detecting an actuation of the at least one turn signal light on one of the sides,
determining that the obstacle is likely to move away from the front of the vehicle.

15. The method of claim 1, wherein the vehicle moves in a traffic slow-down, comprising the further step of consulting a digital map to determine a cause for the traffic slow-down.

16. A system for improving the fuel economy of a vehicle, the system comprising at least one frontal sensor, a combustion engine providing a driving torque, and an electronic control unit receiving input information from the at least one frontal sensor and controlling the combustion engine,
the at least one frontal sensor being configured to detect an obstacle in front of the vehicle and to generate input information relating the detection to the electronic control unit, and
the electronic control unit being configured to determine a relative speed between the vehicle and the obstacle, to determine that the relative speed is below a predetermined value, to determine that the vehicle is decelerating, to determine from the distance and the relative speed between the vehicle and the obstacle that the vehicle will likely continue to decelerate, and to turn off the combustion engine.

17. The system of claim 11, wherein the combustion engine is a hybrid engine with stop-start function.

18. The system of claim 11, wherein the at least one frontal sensor comprises a camera generating an electronic image as input information for the electronic control unit.

19. The system of claim 11, further comprising a GPS communicating with the electronic control unit and having stored digital maps.

20. The system of claim 19, wherein the GPS has a receiver for real-time traffic information.

21. A computer-readable storage medium having stored therein instructions executable by a programmed processor for improving the fuel economy of a vehicle, the vehicle having at least one frontal sensor and a combustion engine providing a driving torque, the storage medium comprising instructions for:
detecting an obstacle in front of the vehicle using the sensor,
determining a relative speed between the vehicle and the obstacle,
determining that the relative speed is below a predetermined value,
determining that the vehicle is decelerating,
determining from the relative speed between the vehicle and the obstacle that the vehicle will likely continue to decelerate, and
turning off the combustion engine.
